(19) United States
(12) Patent Application Publication
(10) Pub. No.: US 2012/0026427 A1
(43) Pub. Date: Feb. 2, 2012

(54) IMAGE DISPLAY APPARATUS AND METHOD OF ASSEMBLING THE SAME

(75) Inventors: Tomohiko OKADA, Osaka (JP); Tetsushi ITO, Osaka (JP); Kenji TANAKA, Osaka (JP); Hirotoshi IEMURA, Osaka (JP); Masaki NISHIZAKA, Osaka (JP); Hiroshi KAMIYAMA, Osaka (JP); Masakatsu KUSUDA, Osaka (JP)

(73) Assignee: SHARP KABUSHIKI KAISHA, Osaka (JP)

(21) Appl. No.: 13/191,779

(22) Filed: Jul. 27, 2011

(30) Foreign Application Priority Data
Jul. 30, 2010 (JP) 2010-173073

(51) Int. Cl. G02F 1/1335; H01J 9/24

(52) U.S. Cl. 349/64; 445/24

(57) ABSTRACT

In an image display apparatus, the diffusing plate includes a rectangular plate body section and diffusing plate projecting sections that project to an outside in parallel with a main surface of the body section. The diffusing plate projecting sections are provided at all perimeter sections that form four sides of a rectangular shape when the body section is viewed from a thickness direction Z thereof. Optical sheets have sheet projecting sections provided at perimeter sections that form two sides parallel to each other among four sides that are rectangular when the sheet body section is viewed from the thickness direction Z. At this time, one optical sheet has sheet projecting sections provided at perimeter sections that form two long sides of the sheet body section. The other optical sheet has sheet projecting sections provided at perimeter section that forms two short sides of the sheet body section.

### CROSS-REFERENCE TO RELATED APPLICATION

This application claims priority to Japanese Patent Application No. 2010-173073, which was filed on Jul. 30, 2010, the contents of which are incorporated herein by reference in its entirety.

### BACKGROUND OF THE TECHNOLOGY

1. Field of the Technology The present technology relates to an image display apparatus including a diffusing plate that diffuses a light from the light source and an optical sheet, and a method of assembling the image display apparatus.

2. Description of the Related Art

In an image display apparatus such as a liquid crystal display apparatus are overlapped a diffusing plate, an optical sheet and the like between a display panel and a light source, and light which is illuminated to the display panel from the light source is controlled to improve image quality of an display image.

A display apparatus described in Japanese Unexamined Patent Publication JP-A 2006-24483 includes a diffusing plate and an optical sheet, and projections are provided on outer perimeters of the diffusing plate and the optical sheet.

A display apparatus described in Japanese Unexamined Patent Publication JP-A 2008-103334 includes a light source unit, a plurality of optical sheets and a mould frame, and each of the optical sheets includes a main body section and a sheet guide section that projects to an outer perimeter. The mould frame is provided with a sheet guide groove where the sheet guide section of the optical sheet is accommodated.

Since the diffusing plate and the optical sheet are made of resin, these members are easily expanded and deformed by heat generated from the light source. Thus, the diffusing plate and the optical sheet are not fixed to a frame using a fixing member. The diffusing plate and the optical sheet are provided with projecting sections and the projecting sections are fitted into holes that are provided in the frame so that the diffusing plate and the optical sheet are retained on the frame as described in JP-A 2006-24483 and JP-A 2008-103334.

Specifically, in a display apparatus of which widths of a bezel and a frame when viewed from a display surface side are made as small as possible, since a projection length of the projecting sections is required to be short, outer perimeter dimensions of the body section of the optical sheet and the diffusing plate, and a dimension of an inner perimeter surface of the frame are required to be precisely concordant with each other to be retained the optical sheet on the frame.

As in the display apparatus described in JP-A 2006-24483, in a case where the projecting sections are provided at four sides of the diffusing plate and the optical sheet, the assembling of the display apparatus is difficult. If the projecting sections of the optical sheet are fitted into the holes that are provided in the frame, an operation that deforms the optical sheet and fits all projections into the holes is required. However, the operation that fits the projections that are provided at four sides into the holes is difficult. Also, if, in a state where the diffusing plate and the optical sheet are overlapped with each other, it is tried to slide these members and fit the projecting sections of the diffusing plate and the projections of the optical sheet into the holes, it is difficult to fit the projections into the holes simultaneously since the diffusing plate is heavy and the optical sheet is light.

### SUMMARY OF THE TECHNOLOGY

An object of the technology is to provide an image display apparatus and a method of assembling the same capable of easily assembling without causing degradation of image quality.

The technology provides an image display apparatus, comprising:

a liquid crystal panel having a liquid crystal element, the liquid crystal panel displaying an image on one surface side thereof by the liquid crystal element;

a base arranged on another surface side of the liquid crystal panel;

a light source provided in the base, the light source illuminating light to the liquid crystal panel from the other surface side of the liquid crystal panel;

a diffusing plate provided between the light source and the liquid crystal panel, the diffusing plate diffusing light that is outputted from the light source, and having a body section of a rectangular shape, and diffusing plate projecting sections that project to an outside in parallel with a main surface of the body section at four sides of the rectangular shape when the body section is viewed in a thickness direction thereof;

a plurality of optical sheets provided between the diffusing plate and the liquid crystal panel, the plurality of optical sheets changing optical characteristics of light that has passed through the diffusing plate, and including a first optical sheet having a first sheet body section of a rectangular thin plate shape and first sheet projecting sections projected to an outside in parallel with a main surface of the first sheet body section only at two long sides parallel to each other, among four sides that make a rectangular shape when the first sheet body section is viewed from a thickness direction thereof, and a second optical sheet having a second sheet body section of a rectangular thin plate shape and second sheet projecting sections projected to an outside in parallel with a main surface of the second sheet body section only at two short sides parallel to each other, among four sides that make a rectangular shape when the second sheet body section is viewed from a thickness direction thereof; and

a fixing structure of a frame shape contacting and retaining the liquid crystal panel, the diffusing plate and the optical sheet from an outside in a planar direction thereof, respectively, the fixing structure including fit holes which are opened in an inner perimeter surface thereof and into which the diffusing plate projecting sections and the sheet projecting sections are fitted.

The diffusing plate is provided between the light source and the liquid crystal panel and the light that is outputted from the light source is diffused at the diffusing plate. Also, the diffusing plate has a body section of a rectangular shape and diffusing plate projecting sections that project to the outside in parallel with the main surface of the body section at four sides that have a rectangular shape when the body section is viewed from the thickness direction thereof.

The optical sheet is provided between the diffusing plate and the liquid crystal panel and changes the optical characteristics of the light that has passed through the diffusing plate. The first optical sheet has a first sheet body section of a rectangular thin plate shape and first sheet projecting sections that project to the outside in parallel with the main surface of the first sheet body section only at two long sides parallel to each other, among four sides that have a rectangular shape when the first sheet body section is viewed from the thickness direction thereof. The second optical sheet has a second sheet body section of a rectangular thin plate shape and second sheet projecting sections that project to the outside in parallel with the main surface of the second sheet body section only at two short sides parallel to each other, among four sides that have a rectangular shape when the second sheet body section is viewed from the thickness direction thereof. The fixing structure includes the fit holes which are opened in the inner perimeter surface and into which the diffusing plate projecting sections and the sheet projecting sections are fitted.

Accordingly, after center sections of the side not containing the sheet projecting sections are in a bending state, the first optical sheet and the second optical sheet are returned to a planar state, and it is possible to fit the first sheet projecting sections and the second sheet projecting sections into the fit holes.

Also, the first sheet projecting sections and the second sheet projecting sections are fitted into the fit holes along with the diffusing plate projecting sections, and the light that has passed through only the diffusing plate is not outputted, so that unevenness of brightness is generated.

Accordingly, it is possible to assemble the image display apparatus easily without deteriorating image quality.

Further, it is preferable that opposite end portions of the diffusing plate projecting sections and the sheet projecting sections in a projection direction thereof are formed in a taper shape.

Opposite end portions of the diffusing plate projecting sections and the sheet projecting sections in the projection direction thereof are formed in a taper shape, so that it is possible to prevent generation of deformation or damage of the projecting sections due to contact with the fit holes when the projections are fitted into the fit holes.

Further, it is preferable that the first optical sheet is provided on the liquid crystal panel side with respect to the second optical sheet.

The first optical sheet is provided on the liquid crystal panel side with respect to the second optical sheet.

Since the sheet projecting sections are provided at the long sides, the first optical sheet is bent a little in a using state and it is also possible to prevent contact with the liquid crystal panel.

Further, it is preferable that at least one of the first sheet projecting sections and the second sheet projecting sections of the first optical sheet and the second optical sheet is provided at asymmetrical positions in two sides parallel to each other.

At least one of the first sheet projecting sections and the second sheet projecting sections of the first optical sheet and the second optical sheet is provided at asymmetrical positions in two sides parallel to each other.

There is a case where surface states of the optical sheet are different between the back surface and the front surface, and in this case, directions of arrangement of the optical sheets are predetermined. The sheet projecting sections are at the asymmetrical positions, whereby it is possible to prevent a failure of an operation in which the front and the back surfaces are arranged differently.

Further, it is preferable that the fixing structure is formed of a plurality of fixing members.

The fixing structure is formed of a plurality of fixing members. For example, the diffusing plate can be arranged in a state where the fixing member of a portion of the fixing structure is separated.

Further, it is preferable that the optical sheet further includes a third optical sheet of a rectangular thin plate shape and third sheet projecting sections projected to an outside in parallel with a main surface of the third body section only at two long sides parallel to each other, among four sides that have a rectangular shape when the third sheet body section is viewed from a thickness direction thereof, and

the first sheet projecting sections of the first optical sheet are provided only in one side area of two sides in a longitudinal direction thereof, the third sheet projecting sections of the third optical sheet are provided only in the other side area of two sides in the longitudinal direction thereof, and the first optical sheet and the third optical sheet have rotational symmetry.

The first sheet projecting sections of the first optical sheet are provided only in one side area of two sides in the longitudinal direction thereof, the third sheet projecting sections of the third optical sheet are provided only in the other side area of two sides in longitudinal direction thereof. The first optical sheet and the third optical sheet are constituted so as to have rotational symmetry.

The first optical sheet and the third optical sheet are substantially identical to each other and may be used in a state of rotation of 180°.

Further, the technology provides a method of assembling the image display apparatus mentioned above, comprising:

a first step of arranging the diffusing plate on the fixing structure,

a second step of contacting the second sheet projecting sections with a surface of the diffusing plate that is arranged in a state where the second sheet body section is bent at a center of the long side, returning the bending state of the second sheet body section to a planar state, and fitting the second sheet projecting sections into the fit holes of the fixing structure,

a third step of contacting the first sheet projecting sections with a surface of the second optical sheet that is arranged in a state where the first sheet body section is bent at a center of the short side, returning the bending state of the first sheet body section to a planar state, and fitting the first sheet projecting sections into the fit holes of the fixing structure, and

a fourth step of arranging the liquid crystal panel on the fixing structure.

At the second step, the second projecting sections come in contact with the surface of the diffusing plate that is arranged in a state where the second sheet body section is bent at the center of the long side, the bending state of the second sheet body section returns to the planar state, and the second sheet projecting sections are fitted into the fit holes of the fixing structure. At the third step, the first sheet projecting sections come in contact with the surface of the second optical sheet that is arranged in a state where the first sheet body section is bent at the center of the short side, the bending state of the first sheet body section returns to the planar state, and the first sheet projecting sections are fitted into the fit holes of the fixing structure.

Accordingly, it is possible to assemble the image display apparatus easily assembled without deteriorating image quality.

Further, it is preferable that at the second step and the third step, shafts are arranged on lower sides of the first sheet body section and the second sheet body section, and the first optical sheet and the second optical sheet are in a bending state by the shafts, the shafts are then lowered, and the shafts are drawn out in an extending direction thereof, whereby the first projecting sections and the second projecting sections are fitted into the fit holes.

At the second step and the third step, shafts are arranged on lower sides of the first sheet body section and the second sheet body section, and the first optical sheet and the second optical sheet are in a bending state by the shafts, the shafts are then lowered, and the shafts are drawn out in the extending direction thereof, whereby the first sheet projecting sections and the second sheet projecting sections are fitted into the fit holes.

Accordingly, an assembling process can be easily automated without operator.

### BRIEF DESCRIPTION OF THE DRAWINGS

Other and further objects, features, and advantages of the technology will be more explicit from the following detailed description taken with reference to the drawings wherein:

FIG. 1 is a cross-sectional view illustrating an image display apparatus according to an embodiment;

FIG. 2 is an exploded perspective view illustrating the construction of the image display apparatus;

FIGS. 3A to 3C are plan views of an optical sheet and a diffusing plate;

FIGS. 4A and 4B are exterior views illustrating the constitution of a displacement preventing member;

FIGS. 5A to 5C are drawings illustrating an arrangement procedure of the diffusing plate;

FIGS. 6A to 6D are drawings illustrating an arrangement procedure of the optical sheet;

FIG. 7 is a plan view illustrating an optical sheet according to another embodiment;

FIGS. 8A and 8B are plan views illustrating two optical sheets in another embodiment in which three or more optical sheets are used; and

FIG. 9 is a drawing illustrating a sheet projecting section having a taper portion.

### DETAILED DESCRIPTION

Now referring to the drawings, preferred embodiments are described detail below.

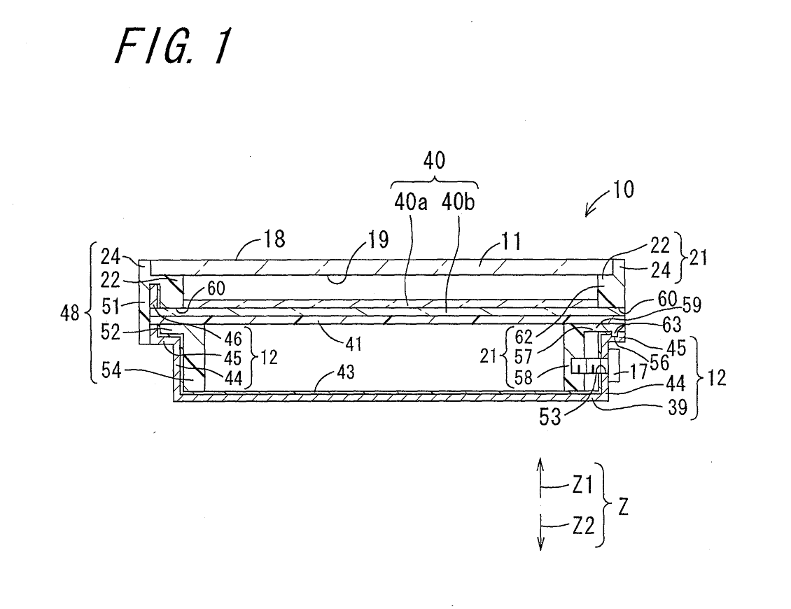

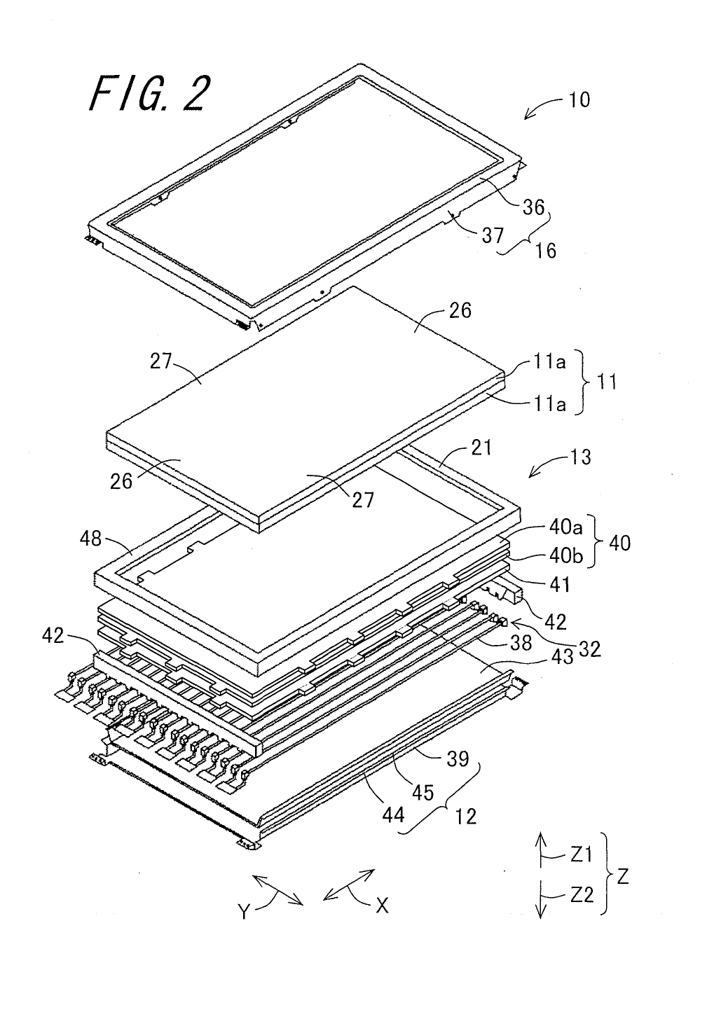

FIG. 1 is a cross-sectional view illustrating an image display apparatus 10 according to an embodiment. In FIG. 1, a light source and a lamp holder are omitted. FIG. 2 is an exploded perspective view illustrating the construction of the image display apparatus 10.

The image display apparatus 10 includes a liquid crystal panel 11 in the embodiment and is a liquid crystal display apparatus that displays an image. Referring to FIGS. 1 and 2, the image display apparatus 10 comprises the liquid crystal panel 11, a chassis 12, a fixing structure 13, a frame section 16, a connecting member 17, an optical sheet 40 and a diffusing plate 41.

In the first embodiment, the image display apparatus 10 is an apparatus that displays the image on a display screen by outputting image information in a television, a personal computer or the like. The liquid crystal panel 11 having a liquid crystal element forms the display screen and the liquid crystal panel 11 is formed in a plate shape. In the liquid crystal panel 11, two directions of the thickness direction Z are defined as a front side Z1 and a back side Z2.

The liquid crystal panel 11 has the liquid crystal element and displays the image on an one surface 18 side by the liquid crystal element. The chassis 12 is a base that is used to fix the liquid crystal panel 11 and is arranged on the other surface 19 side with respect to the liquid crystal panel 11. One surface 18 side is the front side Z1 and the other surface 19 side is the back side Z2.

The fixing structure 13 comprises a plurality of members that assists fixing of the liquid crystal panel 11 and it is desirable that the plurality of members is constituted by dividable members. The fixing structure 13 includes one or more displacement preventing members 21 and the displacement preventing member 21 has an opposing section 22 and a contacting section 24. The opposing section 22 is opposed from the other surface 19 side to at least a portion of the outer perimeter portion of the liquid crystal panel 11 when the liquid crystal panel 11 is viewed from the thickness direction Z. The contacting section 24 contacts with the outer perimeter portion from the outside of the liquid crystal panel 11 in a planar direction thereof. The frame section 16 is opposed to the outer perimeter portion of the liquid crystal panel 11 on one surface 18 side and holds the outer perimeter portion in corporation with the fixing structure 13. Accordingly, a relative displacement of the liquid crystal panel 11 toward one surface 18 side with respect to the frame section 16 is prevented. The connecting member 17 connects the displacement preventing member 21 to the chassis 12.

The liquid crystal panel 11 is formed in a rectangular plate shape and the displacement preventing member 21 contacts with a portion that forms at least one side of the outer perimeter portion of the liquid crystal panel 11 from the outside of the liquid crystal panel 11 in the planar direction thereof. Accordingly, in a case where the displacement preventing member 21 is provided in the portion that forms the one side, the displacement preventing member 21 is separable from a member that constitutes the fixing structure 13 at the other three sides.

The portion that constitutes at least one side where the displacement preventing member 21 contacts with one side from the outside of the liquid crystal panel 11 in the planar direction thereof, includes one of a pair of end portions 26 that forms short sides of the liquid crystal panel 11.

The displacement preventing member 21 has an engaging section that engages with the chassis 12, and the chassis 12 has an engaged section that is engaged with the engaging section. In a state where the engaging section engages the engaged section and connection of the chassis 12 and the displacement preventing member 21 by the connecting member 17 is released, the contacting section 24 can be angularly displaced with respect to the chassis 12 about the engaged section as the fulcrum. Also, the contacting section 24 is close to and is apart from the liquid crystal panel 11 by an angular displacement.

The connecting member 17 is constituted by a screw member and connects the displacement preventing member 21 to the chassis 12 by screwing to the displacement preventing member 21. Also, the screw member advances and retreats with respect to the displacement preventing member 21 according to an angular displacement with respect to the displacement preventing member 21. The contacting section 24 of the displacement preventing member 21 angularly displaces according to the advancing and retreating of the screw member with respect to the displacement preventing member 21.

The image display apparatus 10 displays an image visibly when viewed from the front side Z1. In the image display apparatus 10, the terms “the front side” (Z1) and “the back side” (Z2) regarding plate shape components that are arranged in parallel with the liquid crystal panel 11 are used as indicating directions the same as those in the case of the liquid crystal panel 11. In the image display apparatus 10, the frame section 16 that surrounds the perimeter of the liquid crystal panel 11 from the outside of the planar direction thereof is a so-called thin bezel. For example, when the image display apparatus 10 is used in a multi-display system, a plurality of image display apparatuses 10 is arranged along one direction or in matrix. At this time, a portion that corresponds to a boundary line of the image display apparatuses 10 adjacent to each other, in other words, the frame section 16 is a non-display portion where the image is not displayed. In the multi-display, an image to be displayed on the image display apparatuses 10 adjacent to each other is originally a sequential image, however in a case where the width of the frame section 16 when viewed from the Z direction is large, the width of the non-display portion becomes large. In the image display apparatus 10 used for the multi-display system, in order to make the width of the non-display portion as small as possible, the frame section 16 having a small width, that is, thin bezel is required. The image display apparatus 10 of the first embodiment is a thin-bezel liquid crystal display apparatus in which a diagonal length of the liquid crystal panel 11 is 60 inches and an aspect ratio is 9:16.

The image display apparatus 10 includes a plurality of light sources 32 that are arranged on the back side with respect to the liquid crystal panel 11 (refer to FIG. 2). The plurality of the light sources 32 are attached to the chassis 12. Light outputted from the light source 32 passes through the diffusing plate 41 and the optical sheet 40. Furthermore, the light is outputted on the front side with respect to the image display apparatus 10 through the liquid crystal panel 11 and is used as display light that performs the image display. As the light source 32, various light emitting members such as a fluorescent tube or an LED (Light Emitting Diode) may be used. The frame section 16 constitutes a portion of a housing that accommodates the liquid crystal panel 11, the chassis 12, the fixing structure 13, the connecting member 17 and the light source 32.

The housing of the first embodiment has the frame section 16 and a back side member that constitutes the housing together with the frame section 16. The frame section 16 is arranged so as to extend to the outside of the liquid crystal panel 11 in the planar direction viewed from the front side Z1, and the frame section 16 alone or together with the back side member defines an interior space.

The frame section 16 and the liquid crystal panel 11 are formed in the rectangular shape when the image display apparatus 10 is viewed from the front side Z1. The rectangular shape may be arranged in landscape orientation or arranged in portrait orientation as a usual posture when the image display apparatus 10 displays the image. In the first embodiment, the rectangular shape is arranged in landscape orientation. The frame section 16 includes a plate shape portion 36 that is perpendicular to the thickness direction Z and an outer perimeter portion 37 that surrounds the liquid crystal panel 11 from the outside in the planar direction thereof. The plate shape portion 36 holds the liquid crystal panel 11 in corporation with the fixing structure 13.

The liquid crystal panel 11 includes two substrates 11a and is formed in the rectangular plate shape when the liquid crystal panel 11 is viewed from the thickness direction Z. The liquid crystal panel 11 includes switch elements such as TFTs (Thin Film Transistors), and the liquid crystal is injected into a gap between the two substrates 11a. The liquid crystal display panel is irradiated with the light from the light source 32 of the back side as backlight so that the display function is exerted. A driver for controlling the driving of the pixel (a source driver) in the liquid crystal panel 11, various elements and wirings are provided on the two substrates 11a.

The fixing structure 13 is arranged on the back side with respect to the liquid crystal panel 11 and arranged on the front side with respect to the chassis 12, and is attached to the chassis 12. The structure of the fixing structure 13 is described below in detail. The optical sheet 40, the diffusing plate 41, the lamp holder 42, the light source 32 and a reflecting sheet 43 are arranged between the fixing structure 13 and the chassis 12. The light source 32 includes, for example, a plurality of fluorescent tubes 38 and the lamp holder 42 attaches the fluorescent tubes 38 to the chassis 12. The diffusing plate 41 is arranged on the front side with respect to the fluorescent tubes 38 and the optical sheet 40 is arranged on the front side of the diffusing plate 41. The diffusing plate 41 and the optical sheet 40 are arranged in parallel with the liquid crystal panel 11.

The diffusing plate 41 diffuses light that is emitted from the fluorescent tubes 38 in the planar direction thereof so that brightness is prevented from being uneven locally. The optical sheet 40 comprises a plurality of optical sheets, and in the embodiment, is constituted by two optical sheets composed of an optical sheet 40a and an optical sheet 40b. The optical sheet 40 is formed of a functional resin sheet that has various functions so as to enhance the display quality. For example, the optical sheet 40 has such a function that a traveling direction of light that arrives from the back side through the diffusing plate 41 is directed to the front side. The traveling direction of light includes many planar direction components as vector components in the diffusing plate 41 so as to prevent unevenness of brightness in the planar direction. Meanwhile, the optical sheet 40 converts the traveling direction of light that includes many vector components in the planar direction to the traveling direction of the light that includes many thickness direction Z components. Specifically, the optical sheet 40 forms a large number of portions that are formed in a lens or a prism shape side by side in the planar direction so that the degree of the diffusion of the light that is traveled in the thickness direction Z is reduced. Accordingly, in the display performed by the image display apparatus 10, it is possible to enhance brightness.

The chassis 12 includes a plate-shaped bottom section 39 that is perpendicular to the thickness direction Z, a sidewall section 44 that continues to the bottom section 39 and is upright from the bottom section 39, and a plate-shaped flange section 45 that continues to a portion that is opposed to the portion that continues to the bottom section 39 among the sidewall section 44, and extends in parallel with the bottom section 39. The bottom section 39 is formed in the rectangular shape when viewed from the thickness direction Z. The sidewall section 44 is formed upright to the front side from the two end portions 26 that form the short sides and two end portions 27 that form the long sides among the bottom section 39. Accordingly, four plate-shaped sidewall sections 44 are formed on the perimeter of the bottom section 39.

Each of the sidewall sections 44 is formed in a strip shape and is parallel with the thickness direction Z of the bottom section 39. A flange section 45 is connected to the end portion on the front side of the sidewall sections 44. The flange section 45 is formed so as to extend to the outside in the planar direction with respect to the bottom section 39 when the flange section 45 is viewed from the thickness direction Z. The flange section 45 is formed in an elongated strip shape that is perpendicular to the thickness direction Z of the bottom section 39. Accordingly, the flange sections 45 are formed in four similarly to the sidewall sections 44.

Thus, four flange sections 45 are formed in the rectangular shape when the flange sections 45 is viewed in the thickness direction Z. The term “perpendicular” includes both meanings of ‘ideally perpendicular’ and ‘substantially perpendicular’, and “parallel” includes both meanings of ‘ideally parallel’ and ‘substantially parallel’.

The liquid crystal panel 11, the bottom section 39 of the chassis 12, the optical sheet 40 and the diffusing plate 41 are formed in a rectangular shape when the liquid crystal panel 11 is viewed from the thickness direction Z. Their long side directions X are parallel to each other and their short side directions Y are parallel to each other.

In the first embodiment, there is formed a collar section 46 projecting to the front side from an end portion of the flange section 45 that is on an opposite side to the end portion where the sidewall section 44 connects and is located outwardly in the planar direction with respect to the bottom section 39. The collar section 46 is formed in a strip shape parallel in the thickness direction Z. The collar sections 46 are formed corresponding to three flange sections 45 among four flange sections 45. In the first embodiment, the collar sections 46 are formed corresponding to one among two flange sections 45 that form the short sides and two flange sections 45 that form the long sides. The collar section 46 is not formed at the other one among two flange sections 45 that form the short sides.

The reflecting sheet 43 is arranged in contact with at least a portion of a surface on the front side of the bottom section 39 and the flange sections 45. The reflecting sheet 43 may be arranged in contact with or may be arranged in non-contact with the sidewall section 44. A surface of the reflecting sheet 43 that faces at least front side has high reflectivity with respect to light from the light source 32, and ideally reflectivity of 100%.

The plurality of fluorescent tubes 38 are arranged near to the front side with respect to the bottom section 39 and the reflecting sheet 43 that is arranged on the front side of the bottom section 39. Each of the fluorescent tubes 38 is arranged to extend in the long side direction X of the bottom section 39. The lamp holders 42 fix both end portions in the longitudinal direction of the plurality of fluorescent tubes 38 to the chassis 12. A lamp holder 42 that is arranged on one side in the longitudinal direction of the fluorescent tubes 38 and a lamp holder 42 that is arranged on the other side in the longitudinal direction of the fluorescent tubes 38 are formed in substantially rectangular parallelepiped respectively, and a surface of the rectangular parallelepiped that faces the front side is arranged perpendicular to the thickness direction Z.

Each of the lamp holders 42 is arranged inside with respect to the sidewall section 44 and the surface of each of the lamp holders 42 that faces the front side is arranged within one plane along with the surface of the flange section 45 that faces the front side. The outer perimeter portion of the diffusing plate 41 is arranged in contact with these surfaces. The liquid crystal panel 11, the fixing structure 13, the optical sheet 40, the diffusing plate 41, the lamp holders 42, the fluorescent tubes 38, the reflecting sheet 43 and the chassis 12 are arranged inside the planar direction regarding the liquid crystal panel 11 with respect to the outer perimeter portion 37 of the frame section.

In the first embodiment, the fixing structure 13 includes the displacement preventing member 21 and a fit fixing member 48 that is fixed by fitting to the chassis 12. The fit fixing member 48 is fixed by fitting at least to the collar section 46 of the chassis 12. In the first embodiment, the fit fixing member 48 includes a fitting section 51 that forms a recessed groove 49 in which the collar section 46 is to be inserted, a flat section 52 that continues to the fitting section 51 and covers the front side of the flange section 45, and an inside section 54 that covers the sidewall section 44 of the chassis 12 from an inside perimeter side.

On the front side of the fitting section 51, the opposing section 22 and the contacting section 24 are formed. The opposing section 22 faces the front surface side and is opposed to the outer perimeter portion of the liquid crystal panel 11. The contacting section 24 projects to the front side in the outside in the planar direction with respect to the opposing section 22 and contacts with the liquid crystal panel 11 from the outside in the planar direction thereof. The opposing section 22 is a portion that holds the outer perimeter portion of the liquid crystal panel 11 in corporation with the plate shape portion 36 of the frame section 16. Accordingly, the opposing section 22 is required to be reliably opposed to the outer perimeter portion of the liquid crystal panel 11. Also, the opposing section 22 can easily realize the thin bezel when the opposing section 22 is set as thin as possible.

Regarding the opposing section 22 that contacts with the end portion forming each side of the liquid crystal panel 11, the dimension of the opposing section 22 in a direction that is perpendicular to both of the thickness direction Z and an extension direction of each side is called as “width dimension”. As an example of the image display apparatus 10, in a case of the image display apparatus 10 of is 60 inches, with respect to an image display area of the liquid crystal panel 11, the dimension in the long side direction X is about 133 cm and the dimension in the short side direction Y is about 75 cm. In this case, the dimension of the opposing section 22 is set to about 3 mm.

The fit fixing member 48 is integrally formed in a shape that forms three sides of the rectangular shape corresponding to three sides having the collar section 46. Accordingly, the end portion on the front side of the inside section 54 is formed to continue to the inside end portion of the flat section 52 in the planar direction thereof. The inside section 54 includes three plate shape portions parallel in the thickness direction Z of the liquid crystal panel 11. One or more through holes 53 are formed at a portion of each of plate shape portions. The connecting member 17 that is realized by the screw member is inserted into the through hole 53 perpendicular to each of the plate shape portions.

The displacement preventing member 21 is provided corresponding to the portion not containing the collar section 46, among four flange sections 45. Accordingly, the displacement preventing member 21 is formed to define one side among four sides that form the rectangular shape. The displacement preventing member 21 is provided so as to be angularly displaceable about the portion of the flange section 45 as the fulcrum. A portion that turns to the fulcrum when the displacement preventing member 21 is angularly displaced is formed in the flange section 45 not containing the collar section 46. Specifically, one or more recesses 56 are formed in the flange section 45 not containing the collar section 46 at one or more positions and a portion of the displacement preventing member 21 is engaged with the one or more recesses 56.

The displacement preventing member 21 includes a fulcrum contacting section 57, a connected section 58 and an angular displacement section 62. The fulcrum contacting section 57 covers the front side of the flange section 45 and contacts with a portion that turns to the fulcrum of the angular displacement of the flange section 45. The connected section 58 continues the fulcrum contacting section 57, covers the sidewall section 44 of the chassis 12 from the inside perimeter side and is connected to the chassis 12 by the connecting member 17. The angular displacement section 62 is formed in a shape upright to the front side from the flat section 52.

The fulcrum contacting section 57 is constituted by a plate shape portion 59 having a plate shape parallel with the bottom section 39 of the chassis 12 and a protruding portion 63 that protrudes to the back side from the plate shape portion 59. The protruding portion 63 is an engaging section that engages with the recess 56 formed at the flange section 45. The recess 56 that is formed in the flange section 45 is an engaged section that is engaged with the protruding portion 63 that is formed in the displacement preventing member 21. Accordingly, the displacement preventing member 21 can be angularly displaced about the recess 56 of the flange sections 45 as the fulcrum.

In the displacement preventing member 21, the connected section 58 is formed in parallel with the thickness direction Z of the liquid crystal panel 11, continues to the end portion of the fulcrum contacting section 57 located inside the planar direction regarding the liquid crystal panel 11 and is formed to extend on the back side. Recess portions are formed in the connected section 58 and female screws are formed in the recess portions. The recess portion is formed without penetrating the connected section 58. Accordingly, the light is prevented from penetrating the connected section 58.

The angular displacement section 62 and the connected section 58 are formed parallel in the thickness direction Z of the liquid crystal panel 11, continues to the end portion of the fulcrum contacting section 57 located outside the planar direction regarding the liquid crystal panel 11 and is formed to extend on the front side. On the front side of the angular displacement section 62, the opposing section 22 and the contacting section 24 are formed. The opposing section 22 faces the front side and is opposed to the outer perimeter portion of the liquid crystal panel 11. The contacting section 24 projects to the front side in the outside of the planar direction with respect to the opposing section 22 and contacts with the liquid crystal panel 11 from the outside in the planar direction. The opposing section 22 of the displacement preventing member 21 is also a portion that holds the outer perimeter portion of the liquid crystal panel 11 in corporation with the plate shape portion 36 of the frame section 16. Accordingly, the opposing section 22 is required to be reliably opposed to the outer perimeter portion of the liquid crystal panel 11, and the opposing section 22 can easily realize the thin bezel when the opposing section 22 is set as thin as possible.

In the thickness direction Z of the liquid crystal panel 11, the dimension of the contacting section 24 is substantially identical to the dimension of the thickness of the liquid crystal panel 11 but is set to be slightly small. Accordingly, when the plate shape member of the frame section 16 is contacted from the front side of the outer perimeter portion of the liquid crystal panel 11 and holds the liquid crystal panel 11 in corporation with the opposing section 22, the liquid crystal panel 11 can be prevented from rattling in the thickness direction Z.

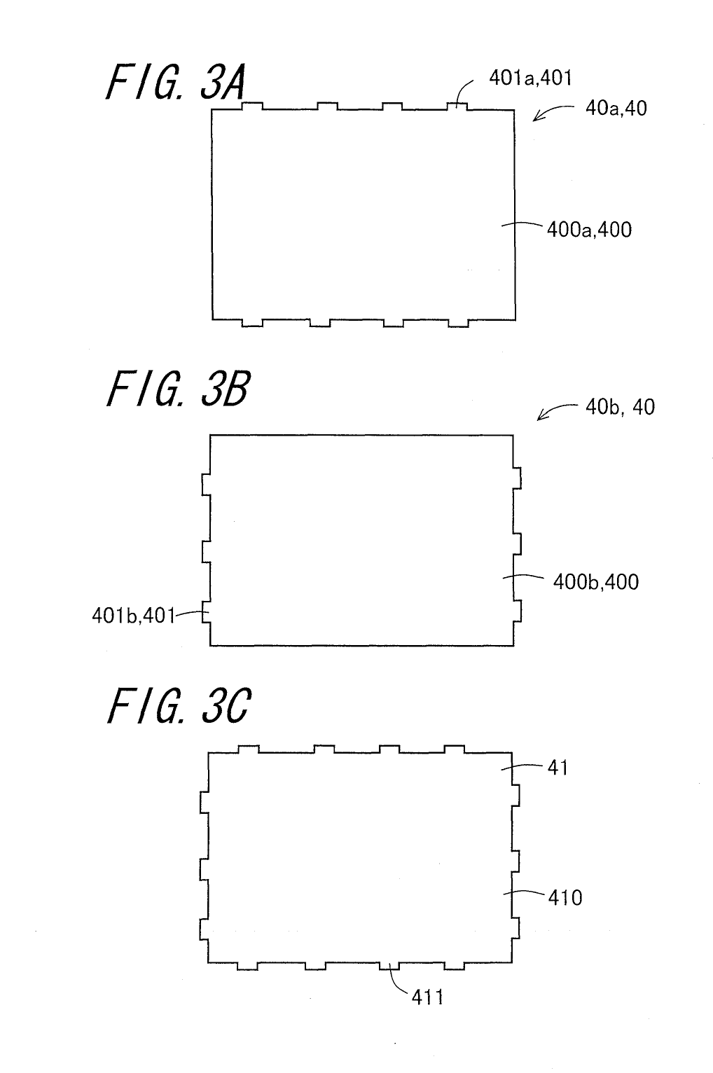

The optical sheet 40 comprises a sheet body section 400 having a rectangular thin plate shape and sheet projecting sections 401 that project toward the outside in a direction parallel with a main surface of the sheet body section 400. In the embodiment, the optical sheet 40 is constituted by two optical sheets composed of the optical sheet 40a and the optical sheet 40b. FIGS. 3A to 3C are plan views illustrating the optical sheets 40a and 40b, and the diffusing plate 41. FIG. 3A is a plan view of the optical sheet 40a, FIG. 3B is a plan view of the optical sheet 40b, and FIG. 3C is a plan view of the diffusing plate 41.

The optical sheet 40a is constituted by a sheet body section 400a having a rectangular thin plate shape and sheet projecting sections 401a that project toward the outside in parallel with a main surface of the sheet body section 400a. The optical sheet 40b is constituted by a sheet body section 400b having a rectangular thin plate shape and sheet projecting sections 401b that project toward the outside in parallel with a main surface of the sheet body section 400b.

The diffusing plate 41 is constituted by a body section 410 having a rectangular shape and diffusing plate projecting sections 411 that project toward the outside in parallel with a main surface of the body section 410. The diffusing plate projecting sections 411 are provided in the entire of the perimeter section that forms four sides that are a rectangular when the body section 410 is viewed from the thickness direction Z.

Meanwhile, in the optical sheet 40, the sheet projecting sections 401 are provided in the perimeter section that forms two sides parallel to each other among four sides that are rectangular when the sheet body section 400 is viewed from the thickness direction Z. At this time, among the two optical sheets 40a and 40b, for example, the optical sheet 40a is provided with the sheet projecting sections 401a in the perimeter section that forms two long sides of the sheet body section 400a, and the optical sheet 40b is provided with the sheet projecting sections 401b in the perimeter section that forms two short sides of the sheet body section 400b.

The diffusing plate projecting sections 411 and the sheet projecting sections 401 of the optical sheet 40 are provided at positions corresponding to each other in the thickness direction Z in a state where the diffusing plate 41 and the optical sheet 40 are overlaid on each other. Also, the shape of the diffusing plate projecting section 411 and the shape of the sheet projecting section 401 of the optical sheet 40 are substantially identical to each other. The size of the sheet projecting section 401 of the optical sheet 40 and the size of the diffusing plate projecting section 411 are substantially identical to each other or the size of the sheet projecting section 401 of the optical sheet 40 is formed to be slightly larger than the size of the diffusing plate projecting section 411.

The light that is outputted from the light source 32 enters not only the body section 410 but also the diffusing plate projecting section 411 of the diffusing plate 41 and passes through the diffusing plate 41 on the front side. Since the optical sheet 40 is arranged on the front side in the thickness direction with respect to the diffusing plate 41, in a case where the sheet projecting sections 401 are not present at the positions that correspond to the diffusing plate projecting sections 411, the light that has passed through the diffusing plate projecting sections 411 is illuminated to the liquid crystal panel 11 without passing through the sheet projecting sections 401. Accordingly, the light that has passed through both of the diffusing plate 41 and the optical sheet 40, and the light that has passed through only the diffusing plate 41 are present in the light that is illuminated to the liquid crystal panel 11. The two types of illuminated lights generate unevenness of brightness.

In a case where the diffusing plate projecting sections 411 are provided in the entire of the perimeter that forms four sides of the body section 410 of the diffusing plate 41, it is preferable that the sheet projecting sections 401 are provided in the entire of the perimeter that forms four sides of the sheet body section 400, identical to the optical sheet 40. However, when the sheet projecting sections 401 are provided in the entire of the perimeter of the optical sheet 40, it is difficult to provide the optical sheet 40 during the assembling process.

The installation of the optical sheet 40 and the diffusing plate 41 to the fixing structure 13 is performed by fitting the sheet projecting sections 401 and the diffusing plate projecting sections 411 into the fit holes that are provided in the fixing structure 13.

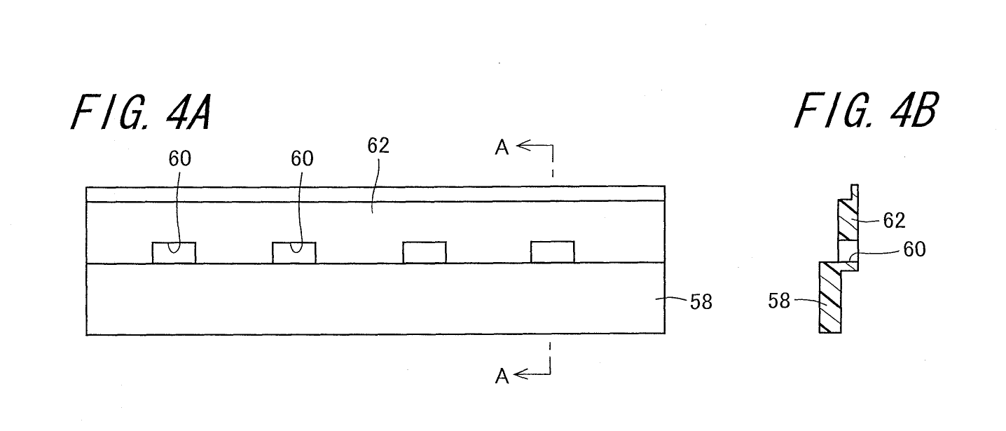

FIGS. 4A and 4B are exterior views illustrating the constitution of the displacement preventing member 21. FIG. 4A is a view illustrating the displacement preventing member 21 that is viewed from the inside perimeter side, and FIG. 4B is a sectional view taken along the line A-A in FIG. 4A. Specifically, the sheet projecting sections 401 and the diffusing plate projecting sections 411 are fitted into fit holes 60 that are opened in the inside perimeter section of the fit fixing member 48 and the displacement preventing member 21, respectively. The fit holes 60 are formed through the entire of the inside perimeter of the whole fixing structure 13. The diffusing plate 41 is retained in the fixing structure 13 by fitting the diffusing plate projecting sections 411 that are provided in the entire of the perimeter section into the fit holes 60 and preventing the diffusing plate projecting sections 411 from loosing from the fit holes 60. The optical sheet 40a is retained in the fixing structure 13 by fitting the sheet projecting sections 401a that are provided in the perimeter section that forms two long sides into the fit holes 60 and preventing the sheet projecting sections 401a from loosing from the fit holes 60, and the optical sheet 40b is retained in the fixing structure 13 by fitting the sheet projecting sections 401b that are provided in the perimeter section that form two short sides into the fit holes 60 and preventing the sheet projecting sections 401b from loosing from the fit holes 60.

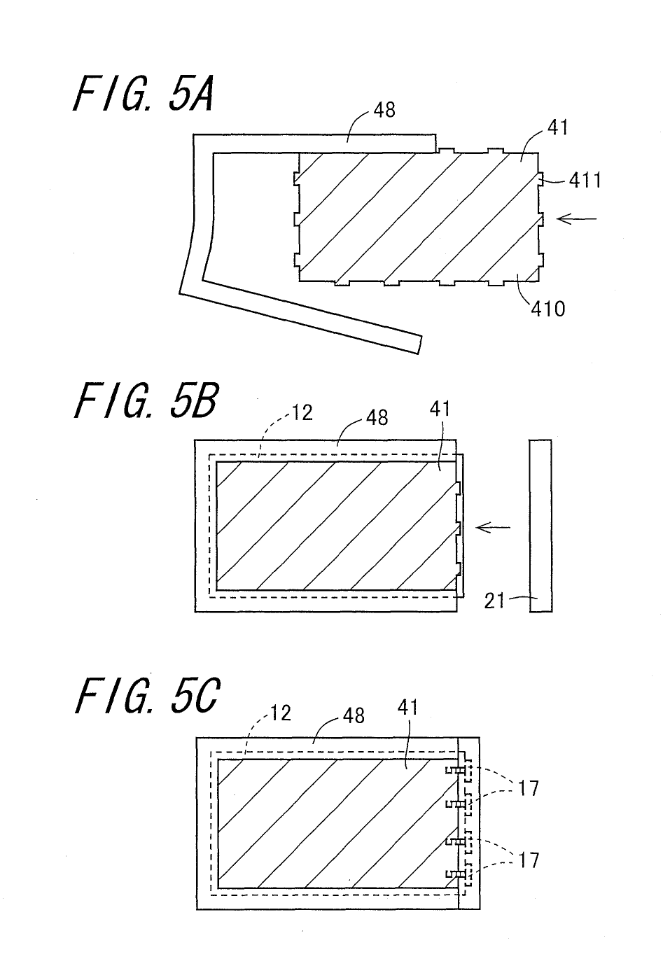

FIGS. 5A to 5C are drawings illustrating an arrangement procedure of the diffusing plate 41. As shown in FIG. 5A, the fit fixing member 48 is deformed so as to open to the outside. The diffusing plate projecting section 411 that are provided in the perimeter section that forms three sides of the diffusing plate 41 are fitted into the fit holes 60 that are provided in the fit fixing member 48. Next, as shown in FIG. 5B, the diffusing plate projecting sections 411 that are provided in the perimeter section that forms remained one side of the diffusing plate 41 are fitted into the fit holes 60 that are provided in the displacement preventing member 21. Finally, as shown in FIG. 50, the displacement preventing member 21 is screwed the chassis 12 by the connecting members 17 and then the arrangement of the diffusing plate 41 is completed. At this time, the optical sheet 40 and the liquid crystal panel 11 are not provided.

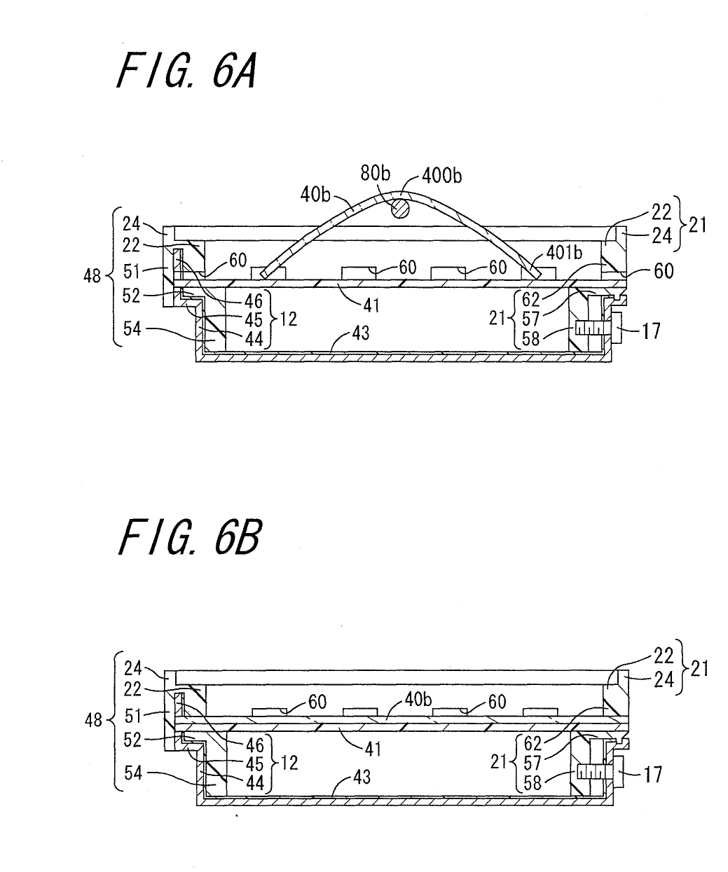

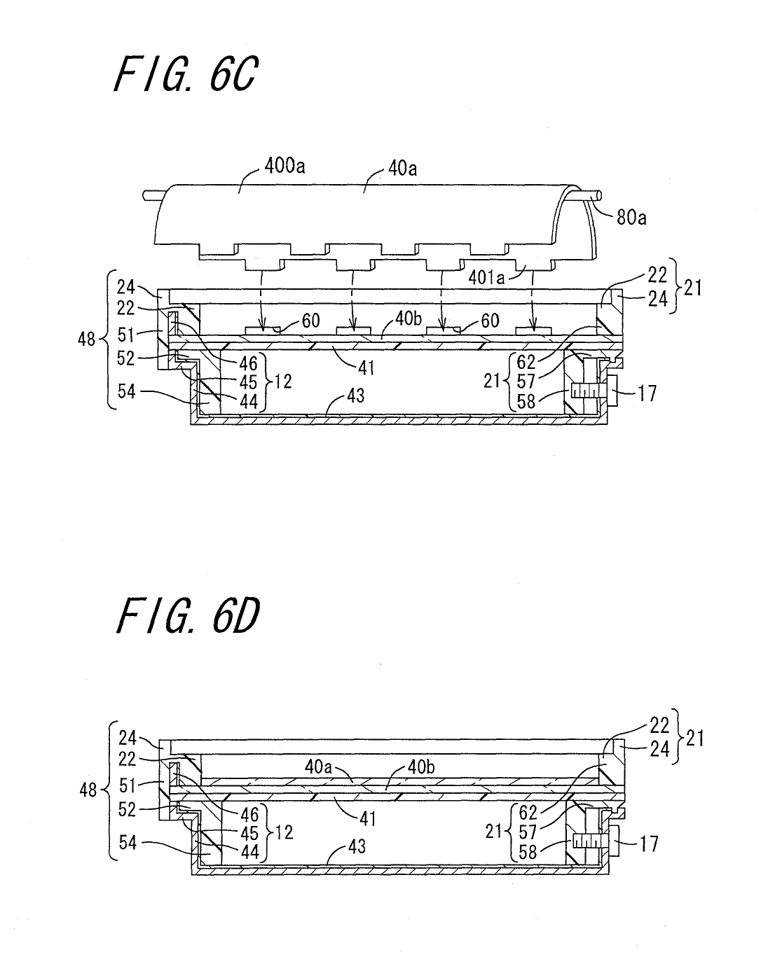

Next, the procedure of setting the optical sheet 40 is described. FIGS. 6A to 6D are drawings illustrating an arrangement procedure of the optical sheet 40.

The optical sheet 40b is arranged in a state where the diffusing plate 41 is arranged in the procedure as shown in FIGS. 5A to 50.

Since the optical sheet 40b provides the sheet projecting sections 401b only in the perimeter section that forms two short sides, in the operation in which the sheet projecting sections 401b are fitted into the fit holes 60, as shown in FIG. 6A, the sheet projecting sections 401b come in contact with the surface of the diffusing plate 41 that is arranged, in a state where the center portion of the sheet body section 400b in the long side is bent. Next, the bending state of the sheet body section 400b returns to the planar state and the sheet projecting sections 401b move along the surface of the body section 410, whereby the sheet projecting sections 401b can be easily fitted into the fit holes 60 as shown in FIG. 6B.

As described above, the optical sheet 40b is arranged in such a procedure. The arrangement of the optical sheet 40a is performed in a state where the optical sheet 40b is arranged. Since the optical sheet 40a has the sheet projecting sections 401a only in the perimeter section that forms two long sides, in the operation in which the sheet projecting sections 401a are fitted into the fit holes 60, as shown in FIG. 6C, the sheet projecting sections 401a come in contact with the surface of the optical sheet 40b that is arranged, in a state where the center portion of the sheet body section 400a in the short side is bent. Next, the bending state of the sheet body section 400a returns to the planar state and the sheet projecting sections 401a move along the surface of the sheet body section 400b, whereby the sheet projecting sections 401a can be easily fitted into the fit holes 60 as shown in FIG. 6D.

Furthermore, as shown in FIG. 6A, in order to bring the sheet body section 400b in a bending state, a shaft 80b is arranged on the lower surface side of the sheet body section 400b and the optical sheet 40b is placed on the shaft 80b. After that, the shaft 80b is lowered and approaches to the diffusing plate 41, and the shaft 80b is drawn out in the extending direction thereof. Thus, the sheet projecting sections 401b can be fitted into the fit holes 60.

Similarly, as shown in FIG. 6C, in order to bring the sheet body section 400a in a bending state, a shaft 80a is arranged on the lower surface side of the sheet body section 400a and the optical sheet 40b is placed on the shaft 80a. After that, the shaft 80a is lowered and approaches to the optical sheet 40b, and the shaft 80a is drawn out in the extending direction thereof. Thus, the sheet projecting sections 401a can be fitted into the fit holes 60.

Note that, in the arrangement procedure, the use of the shafts 80a and 80b is not essential. When an exterior force from two directions that are opposite to each other with respect to the optical sheet 40 are given and the sheet body section 400 is in a bending state of being convex upward, other members may be used or the operator may perform the operation manually.

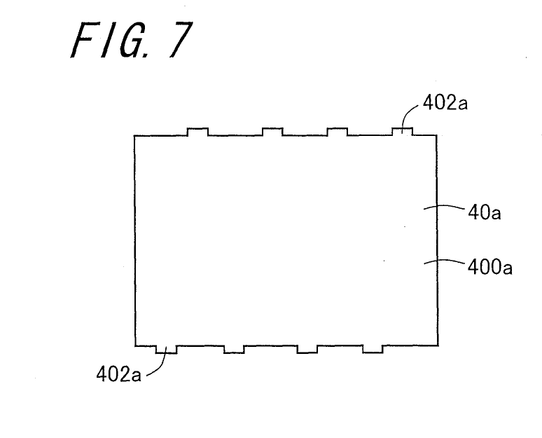

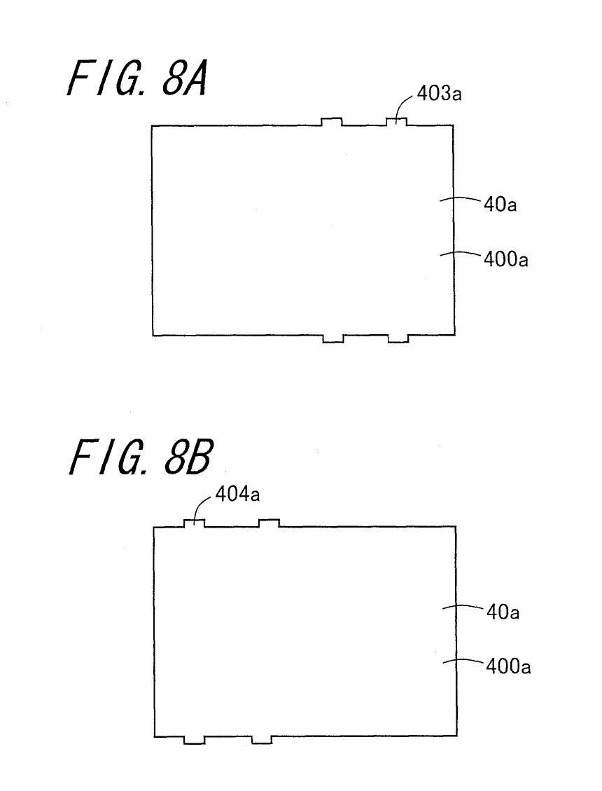

FIG. 7 is a plan view illustrating an optical sheet 40a according to another embodiment.

In above embodiment, in the optical sheet 40a, the sheet projecting sections 401a are provided at symmetrical positions at two long sides. Here, when the optical sheet 40 is arranged, the state of the front surface of the optical sheet 40 differs from the state of the back surface, so that the direction of the arrangement surface is decided in advance. Accordingly, even when the optical sheet 40a is arranged in a wrong state where the front surface and the back surface are reversed, the sheet projecting sections 401 can be fitted into the fit holes 60 in a case where the positions of the sheet projecting sections 401 are symmetrical, and therefore it is required that the operator confirms with their eyes at the time of arrangement or a mark is attached so as to recognize the front and the back surfaces. However, the operation error in which the front and the back surfaces are arranged differently cannot be prevented.

In the embodiment, as shown in FIG. 7, the positions in which the sheet projecting sections 402a are provided at two long sides are asymmetrical. In a case where the sheet projecting sections 402a are provided in asymmetrical, even though the front and the back surfaces are provided in reverse, the positions of the sheet projecting sections 402a and the engaging holes 60 are not identical to each other, the arrangement cannot be performed. Accordingly, the failure of the arrangement in which the front and the back surfaces are arranged differently can be prevented.

Also, the number of the optical sheets 40 of the embodiment is not limited to two, and three or more of the optical sheets may be used. At this time, as above embodiment, the sheet projecting sections may be provided at two long sides or two short sides, and for example, in two optical sheets, the sheet projecting sections are provided at the parallel two sides as the above-described embodiment, but the arrangement positions are not required to be identical to each other. FIGS. 8A and 8B are plan views illustrating two optical sheets 40a in another embodiment in which three or more optical sheets are used.

In the two optical sheets 40a, the sheet projecting sections 403a and 404a are provided in the perimeter section that forms two long sides. Here, in one of the optical sheets 40a, the sheet projecting sections 403a are provided in only one area in the longitudinal direction of the perimeter section that forms two long sides. In the other of the optical sheets 40a, the sheet projecting sections 404a are provided in only the other area in the longitudinal direction of the perimeter section that forms two long sides. In a state where the two optical sheets 40a are overlaid, all of the diffusing plate projecting sections 411 and the sheet projecting sections 403a and 404a of the two optical sheets 40a are formed so as to correspond to each other. In the embodiment, the two optical sheets 40a are formed such that the positions of the sheet projecting sections 403a and 404a have rotational symmetry. Accordingly, the two optical sheets 40a are only different by 180° in the orientation of the planar direction, and the optical sheets 40a are substantially identical to each other. In other words, two optical sheets of one type are prepared and one optical sheet is rotated, whereby they may be used as the optical sheets of two types.

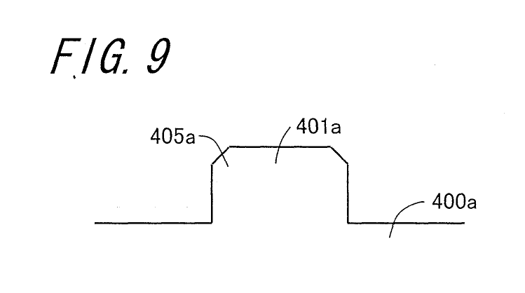

The plate shape viewed from the thickness direction of the projecting sections of the diffusing plate and the sheet projecting sections of the optical sheet may be the rectangular shape for example, however it is preferable that the plate shape is the rectangular shape having a taper portion. FIG. 9 is a drawing illustrating a sheet projecting section 401a having a taper portion 405a. The taper portion 405a is provided on opposite sides in the projecting direction of the sheet projecting section 401a. The dimension in the width in the projecting direction has little gap between the fit holes 60 and the sheet projecting sections 401a, so that it is concerned that the sheet projecting sections 401a come in contact with the perimeter of the fit holes 60 and then the sheet projecting section 401a is cracked or broken when the sheet projecting sections 401a are fitted into the fit holes 60. As described above, by providing the taper portion 405a, the contact thereof can be avoid when the sheet projecting sections 401a are fitted into the fit holes 60, and after fitting, the gap between the sheet projecting sections 401a and the fit holes 60 can be sufficiently small.

The technology may be embodied in other specific forms without departing from the spirit or essential characteristics thereof. The present embodiments are therefore to be considered in all respects as illustrative and not restrictive, the scope of the technology being indicated by the appended claims rather than by the foregoing description and all changes which come within the meaning and the range of equivalency of the claims are therefore intended to be embraced therein.

What is claimed is:

1. An image display apparatus, comprising:
a liquid crystal panel having a liquid crystal element, the liquid crystal panel displaying an image on one surface side thereof by the liquid crystal element;
a base arranged on another surface side of the liquid crystal panel;
a light source provided in the base, the light source illuminating light to the liquid crystal panel from the other surface side of the liquid crystal panel;
a diffusing plate provided between the light source and the liquid crystal panel, the diffusing plate diffusing light that is outputted from the light source, and having a body section of a rectangular shape, and diffusing plate projecting sections that project to an outside in parallel with a main surface of the body section at four sides of the rectangular shape when the body section is viewed in a thickness direction thereof;
a plurality of optical sheets provided between the diffusing plate and the liquid crystal panel, the plurality of optical sheets changing optical characteristics of light that has passed through the diffusing plate, and including a first optical sheet having a first sheet body section of a rectangular thin plate shape and first sheet projecting sections projected to an outside in parallel with a main surface of the first sheet body section only at two long sides parallel to each other, among four sides that make a rectangular shape when the first sheet body section is viewed from a thickness direction thereof, and a second optical sheet having a second sheet body section of a rectangular thin plate shape and second sheet projecting sections projected to an outside in parallel with a main surface of the second sheet body section only at two short sides parallel to each other, among four sides that make a rectangular shape when the second sheet body section is viewed from a thickness direction thereof; and
a fixing structure of a frame shape contacting and retaining the liquid crystal panel, the diffusing plate and the optical sheet from an outside in a planar direction thereof, respectively, the fixing structure including fit holes which are opened in an inner perimeter surface thereof and into which the diffusing plate projecting sections and the sheet projecting sections are fitted.

2. The image display apparatus of claim 1, wherein opposite end portions of the diffusing plate projecting sections and the sheet projecting sections in a projection direction thereof are formed in a taper shape.

3. The image display apparatus of claim 1, wherein the first optical sheet is provided on the liquid crystal panel side with respect to the second optical sheet.

4. The image display apparatus of claim 1, wherein at least one of the first sheet projecting sections and the second sheet projecting sections of the first optical sheet and the second optical sheet is provided at asymmetrical positions in two sides parallel to each other.

5. The image display apparatus of claim 1, wherein the fixing structure is formed of a plurality of fixing members.

6. The image display apparatus of claim 1, wherein the optical sheet further includes a third optical sheet of a rectangular thin plate shape and third sheet projecting sections projected to an outside in parallel with a main surface of the third body section only at two long sides parallel to each other, among four sides that have a rectangular shape when the third sheet body section is viewed from a thickness direction thereof, and
the first sheet projecting sections of the first optical sheet are provided only in one side area of two sides in a longitudinal direction thereof, the third sheet projecting sections of the third optical sheet are provided only in the other side area of two sides in the longitudinal direction thereof, and the first optical sheet and the third optical sheet have rotational symmetry.

7. A method of assembling the image display apparatus of claim 1, comprising:
a first step of arranging the diffusing plate on the fixing structure;
a second step of contacting the second sheet projecting sections with a surface of the diffusing plate that is arranged in a state where the second sheet body section is bent at a center of the long side, returning the bending state of the second sheet body section to a planar state, and fitting the second sheet projecting sections into the fit holes of the fixing structure;
a third step of contacting the first sheet projecting sections with a surface of the second optical sheet that is arranged in a state where the first sheet body section is bent at a center of the short side, returning the bending state of the first sheet body section to a planar state, and fitting the first sheet projecting sections into the fit holes of the fixing structure; and
a fourth step of arranging the liquid crystal panel on the fixing structure.

8. The method of claim 7, wherein at the second step and the third step, shafts are arranged on lower sides of the first sheet body section and the second sheet body section, and the first optical sheet and the second optical sheet are in a bending state by the shafts, the shafts are then lowered, and the shafts are drawn out in an extending direction thereof, whereby the first projecting sections and the second projecting sections are fitted into the fit holes.
